(19) United States
(12) Patent Application Publication
(10) Pub. No.: US 2003/0233252 A1
(43) Pub. Date: Dec. 18, 2003

(54) System and method for providing a generic health care data repository

(76) Inventors: Robert Emmons Haskell, Chester Springs, PA (US); John Andrew Heil, Malvern, PA (US); James Cassidy, Phoenixville, PA (US)

Correspondence Address: Alexander J. Burke, SIEMENS CORPORATION, 1700 WOOD AVENUE SOUTH, ISELIN, NJ, 08830, US

(21) Appl. No.: 10/382,323

(22) Filed: Mar. 5, 2003

Related U.S. Application Data
(60) Provisional application No. 60/362,022, filed on Mar. 6, 2002.

(51) Int. Cl. G06F 17/60

(52) U.S. Cl. 705/2

(57) ABSTRACT

A system for providing a generic healthcare data repository includes an input processor for acquiring healthcare transaction message data in at least one of a plurality of different data formats. A data processor extracts message content type and patient associated identifier information from the transaction message data, processes the transaction message data for storage in a structured repository in a location specified using the patient associated identifier information. A storage processor stores the processed transaction message data in the structured repository.

The present application is a non-provisional application of provisional application No. 60/362,022 by R. E. Haskell et al. filed Mar. 6, 2002.

### BACKGROUND OF THE INVENTION

Known health care record storage systems require installation by qualified professionals to define the meaning and structure of the clinical data to be stored, which can be a lengthy process.

For example, U.S. Pat. No. 6,263,330 issued Jul. 17, 2001 to Bessette discloses a network system for storage of medical records. The records are stored in a database on a server. Each record includes two main parts, namely a collection of data elements containing information of medical nature for the certain individual, and a plurality of pointers providing addresses or remote locations where reside other medical data for that particular individual. Each record also includes a data element indicative of the basic type of medical data found at the location pointed to by a particular pointer. This arrangement permits a client workstation to download the record along with the set of pointers which link the client to the remotely stored files. The identification of the basic type of information that each pointer points to allows the physician to select the ones of interest and thus avoid downloading massive amounts of data where only part of that data is needed at that time. In addition, this record structure allows statistical queries to be effected without the necessity of accessing the data behind the pointers.

For instance, a query can be built based on keys, one of which is the type of data that a pointer points to. The query can thus be performed solely on the basis of the pointers and the remaining information held in the record.

U.S. Pat. No. 6,018,713 issued Jan. 25, 2000 to Coli et al. discloses a network-based system and method for ordering and cumulative results reporting of medical tests. The system includes a computer operated at a physician location (such as a hospital or physician office) to order tests, retrieve and store statistical data or status the progress of previously ordered tests, and at least one labsite computer for receiving physician requests for tests and reporting their results. The physician computer and labsite computer are interconnected by a computer network. The physician computer (a) receives a physician or user request for ordering a test, (b) causes a test request message to be sent to the labsite computer, (c) causes a request for statistical data to be sent to the network, and (d) receives statistical data from the network. The labsite computer is programmed to receive a test request message and to cause a test results message or a test status message to be sent to the physician computer.

U.S. Pat. No. 5,579,393 issued Nov. 26, 1996 to Conner et al. discloses a system for secure medical and dental record interchange comprising a provider system and a payer system. The provider system includes a digital imager, a processing unit, a data transmission/reception device, and a memory having a provider management unit and a security unit. For each image acquired from the digital imager, the provider management unit generates a unique image ID, and creates an image relation structure having a source indicator, a status indicator, and a copy-from indicator. The provider management unit organizes images into a message for transmission to a payer system. The security unit performs message encryption, image signature generation, and message signature generation. The payer system includes a processing unit, a data transmission/reception device, and a memory having a payer management unit and a security unit. The payer system's security unit validates message signatures and image signatures received. The payer management unit generates a message rejection notification or a message acceptance notification. A method for provider-side secure medical and dental record interchange comprises the steps of: acquiring an image; generating a unique image ID and an image relation structure; maintaining a status indicator, a source indicator, and a copy-from indicator; generating an image signature; creating a message that includes the image; and generating a message signature. A method for payer-side secure medical and dental record interchange comprises the steps of: validating a message signature; validating an image signature; and selectively generating a message acceptance notification or a message rejection notification.

Published U.S. Patent Application No. US2002/0007284 published Jan. 17, 2002 for Schurenberg et al. discloses that separate computer systems may participate in a Health Data Network (HDN) such that the computer systems are linked so as to share various types of healthcare-related information. The shared information may include patient record information. The integration of the patient record information is accomplished by maintaining a Global Master Patient Index (GMPI). Such a GMPI may integrate patient record information used by multiple healthcare organizations, facilities, or businesses. Such a GMPI may also integrate patient record information for a single business having multiple sites or computer systems, e.g., a large hospital. The GMPI preferably provides for performing functions such as locating patient records, locating duplicate records for a selected patient, printing a selected patient record with all its duplicate patient records, reconciling potential duplicate patient records found while searching and retrieving a patient's record final reconciliation (certification) of suspected duplicate patients records, maintaining a persistent relationship between patient records in the GMPI, and maintaining a reconciliation audit trail.

Published U.S. Patent Application No. US2001/0051879 published Dec. 13, 2001 for Johnson et al. discloses a system and method for managing security for a distributed healthcare system, such as a system for placing laboratory orders and receiving test results. The network of healthcare businesses that use the system is referred to herein as a Health Data Network, or HDN. When the user log on to the system, the user connects to the system on behalf of a Health Data Network (HDN) Business. Through the user's user account, the user is linked with HDN Businesses. The user may be allowed to log on to the system on behalf of more than one HDN Business. If the user's practice has more than one location or business unit, and all orders and results are shared throughout the practice, the user's practice may be configured as a single HDN Business. In this case, the practice's data may be stored in a central location and can be accessed by all users who have the appropriate permissions. However, if the user's practice has more than one location or business unit, and the need exists to keep orders and results isolated within a location or business unit, the practice may be configured in a parent-child HDN Business relationship. In addition to the ability to log on to the system on behalf of an HDN Business, users also must have permission to actually use the many functions of the system, and need access to the data stored across the HDN. As part of creating the user's permission profile, the user is assigned a role that the user performs when working with the system. This includes information regarding the types of data the user needs to be able to access and the functions the user needs to carry out on that data. Types of data are referred to as objects and functions are referred to as operations. Patient records, lab requisitions, lab results, test codes, ICD-9 codes, lab profiles and physician profiles are examples of objects. An example of an operation is adding new objects. Viewing, modifying, printing, and deleting existing objects are also examples of operations. The process of searching for existing objects is also considered an operation. A role defines what objects a user can access and what operations a user is allowed to carry out on each of those objects.

In all of the above disclosures, data to be stored in a system memory is communicated among facilities in a healthcare enterprise in a known format. In modern healthcare enterprises, respective healthcare facilities may have their own information systems which may be provided by different companies. Each of the information systems expect data to be communicated with them in its expected format, which, however, may be different than the expected formats of the information systems of other facilities in the enterprise. A healthcare data repository which can communicate with all the healthcare facilities in whatever format they use is desirable.

### SUMMARY OF THE INVENTION

In accordance with principles of the present invention, a system for providing a generic healthcare data repository includes an input processor for acquiring healthcare transaction message data in at least one of a plurality of different data formats. A data processor extracts message content type and patient associated identifier information from the transaction message data, processes the transaction message data for storage in a structured repository in a location specified using the patient associated identifier information. A storage processor stores the processed transaction message data in the structured repository.

### BRIEF DESCRIPTION OF THE DRAWINGS

In the drawings:

FIG. 1 is a block diagram of an exemplary embodiment of a system 1000 of the present invention;

FIG. 2 is a block diagram of an exemplary embodiment of a table structure 2000 of the present invention;

FIG. 3 is a flow diagram of an exemplary embodiment of a method 3000 of the present invention; and

FIG. 4 is a block diagram of a processor in which the system illustrated in FIGS. 1 and 2 and the method illustrated in FIG. 3 may be implemented.

### DETAILED DESCRIPTION

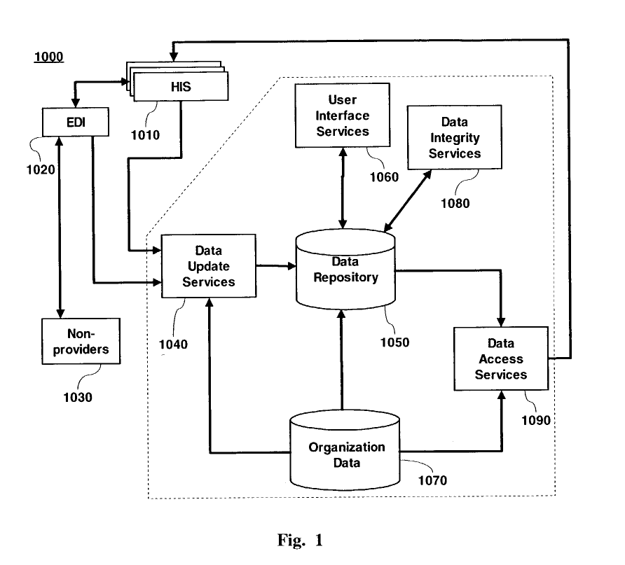

FIG. 1 is a block diagram of an exemplary embodiment of a healthcare system 1000 according to the present invention. A plurality of Health Information Systems (HIS) 1010 are interconnected via an Electronic Data Interchange (EDI) 1020 to non-providers 1030 and to each other. The non-providers 1030 may include outside reference labs, payers, suppliers, and healthcare enterprise laboratories, pharmacies, radiology departments, modality departments, administration operations and/or enterprise orders or results management operations, etc. Transactions with message data are transmitted among the HISs 1010, and non-providers 1030 to exchange data among them.

Data protocols (i.e. formats) for the data exchange may include any protocol, including the known protocols: HL7, XML, DICOM, and/or X12, etc. HIS 1010 and EDI 1020 are also connected to Data Update Services 1040, which in turn is connected to Data Repository 1050. Also connected to Data Repository 1050 are User Interface Services 1060, Organization Database(s) 1070, Data Integrity Services 1080, and/or Data Access Services 1090. Organization Database(s) 1070 is also connected to Data Update Services 1040 and/or Data Access Services 1090. Moreover, Data Access Services 1090 is connected to one or more HIS 1010.

Data Update Services 1040 receives data from the system-to-system EDI 1020 interfaces (e.g. lab results, clinical assessments, claims, remittance advices) and/or from HIS 1010 vendor functions (e.g., lab orders, charting, etc.) and provides a means to update Data Repository 1050 with this data. Data is stored in Data Repository 1050 in the format in which they are received (e.g., HL7 delimited format). Capabilities of Data Update Services 1040 includes transaction parsing, extracting of patient and customer identifiers from transactions, aligning transaction formats to internal repository formats, and/or database updating.

Data Access Services 1090 supports the retrieval of data from the health record data stores (e.g., Data Repository 1050 and/or Organization Database(s) 1070), to satisfy data requests from any HIS 1010. Capabilities of Data Access Services 1090 include cache management, applying corrections, linking patient data, code translation, and/or generating messages, etc. Predetermined rules such as whether correction messages represent full or partial replacement messages (supplied at installation time, as described in more detail below), and translation rules between message types (standard system rules) are necessary to provide this function. User Interface Services 1060 provides the standard user interface functions and screens that may be optionally plugged into a typical HIS vendor system user interface. These standard functions and screens may reflect industry best practice, potentially contributed from the health informatics community.

Both the Data Access Services 1090 and the User Interface Services 1060 retrieve data from the Data Repository 1050 and the Organization Data 1070, and format the data in an appropriate manner. The Data Access Services formats the retrieved data into the transmission format (e.g. X12) required by the requesting HIS 1010. This format may be different from the format the data had when received and stored. The User Interface Services 1060 format the data into a display format as requested by a user. They may be data and/or rules driven in performing this formatting. Further, one skilled in the art will understand that the rules for data retrieval and formatting may be shared by these two services.

Data Integrity Services 1080 assures that the content of the data stores (e.g., Data Repository 1050 and/or Organization Database(s) 1070) are complete and accurate. Capabilities of Data Integrity Services 1080 include balancing, consistency checking, probabilistic matching, validation displays, and/or updating logs, etc.

Rather than follow the traditional design and definition for tables and fields within the tables, Data Repository 1050 is essentially unaware of the data being stored within it. That is, as described above, data is stored in the Data Repository 1050 in the format in which it was received. Thus, the Data Repository 1050 does not need to extract the data from the incoming transaction, but instead stores it still in that format. This allows multiple types of data (e.g., fixed format, health level seven (HL7) format, and/or extended markup language (XML), etc.) to be stored therein without Data Repository 1050 needing to know how to process them at the time they are received. Such an approach allows Data Repository 1050 to act as a data store for any protocol from any HIS system, both receiving and sending data, while being unaware of the format of the content. Data is accepted as it was used in the source systems, and remains unaltered. Edits of data content within the data repository 1050 are neither necessary nor desirable, as described further below.

Within Data Repository 1050, physical databases containing patient information are divided into two portions, active and historical. In some circumstances, this split of the data may allow a more optimal space management and use of database utilities. In addition to this physical data division, because Data Repository 1050 may, in turn, process this data for display purposes, data (both active and historical data) for current patients may be “cached” on local servers. This approach may provide optimal data access times, and may move the processing power requirement for data processing to a lower cost local platform. Also, to support reporting requirements, a copy of the data may be created that has been transformed into a structure accessible by standard report writers or to stage a portion of the repository (current patient data) for more rapid local access to the data by specific organizations and HIS's. This is not necessarily a burdensome cost, since replicates of live relational databases have traditionally been created to provide the indexing needed for such ad-hoc access. This reporting capability may also be provided through a less expensive platform such as through the primary data store of Data Repository 1050.

With regard to transaction processing within system 1000, data supplied to Data Repository 1050 need only include data to identify the customer, patient and type of transaction in order to post that transaction to the Data Repository 1050. On occasion a record containing incomplete or inaccurate data is transmitted through the Data Update Service 1040 for storage in the Data Repository 1050. Updates for such records may be received at a later time. The data from these updates, however, is not used to update the original record. Instead, new records containing such changes are accepted and linked to the original data, thereby allowing the assembly of the final, “correct”, result, as well as showing the path of transactions followed to get there. Therefore, the data content of the original transaction need not be analyzed, nor is replacement logic, for examining the data in the original transaction and the new amending transaction to determine what data in the previously stored record needs to be updated, necessarily processed, as a part of accepting an inbound transaction.

In regard to installation of system 1000, the answers to a set of predetermined questions, such as customer identification, the identification of desired data sources, whether a source system sends complete or partial messages for corrections, the type of messaging protocol used for the source, the location of the patient identifier, and whether embedded medical record numbers are unique, need to be recorded to start storing data in Data Repository 1050. This is in addition to the system-to-system interface setup work of physically tapping the message data stream for collection of the data, which is standard work outside the scope of this invention. Consequently, new customers may be added to existing databases on-the-fly, avoiding traditional setup and management issues, because the system can accommodate any data format from any customer without change to the underlying data processing and storage infrastructure of the data repository 1050.

The Data Repository 1050 may be essentially content unaware, assuming that data needs to be integrated into the workflows of healthcare providers in read-only form. Much of healthcare data is in text form, allowing their access and use by all users. However, as data standards evolve in the health industry, it will be possible to also consistently understand the content of this data across all data sources without the need for extra translation. The objective of the Repository 1050 of the present invention is to store the raw data with little or no installation overhead needed, and to provide shared access to it across time and across providers.

Transactions may be posted directly from the HISs 1010 or the EDI 1020 to Data Repository 1050. The posted transactions are then made immediately available for access at all times. With regard to data storage, the Data Repository 1050 may be partitioned by size (manageable increments) and/or by status (active and historical) so that optimization utilities may be focused where the improvement is needed most. Concerning data access, retrieval of data may be limited to a minimal number of access paths. As described above, replication of the data in the Data Repository 1050 may be used to maintain copies of current patient data on local platforms, which may speed data access.

One skilled in the art will appreciate that the Data Repository 1050 integrates data from all points in the health care delivery system. It therefore requires a security infrastructure to manage/control access. Data sources must be able to automatically and easily retrieve the data they provided, but not automatically gain access to data they did not provide. An authorization scheme must be supported that allows providers 1030 and/or HISs 1010 to grant access to data to other providers, or ultimately for patients to determine who may see their data. And patients should be able to see their data regardless of which provider supplied the data, but never the data of other patients.

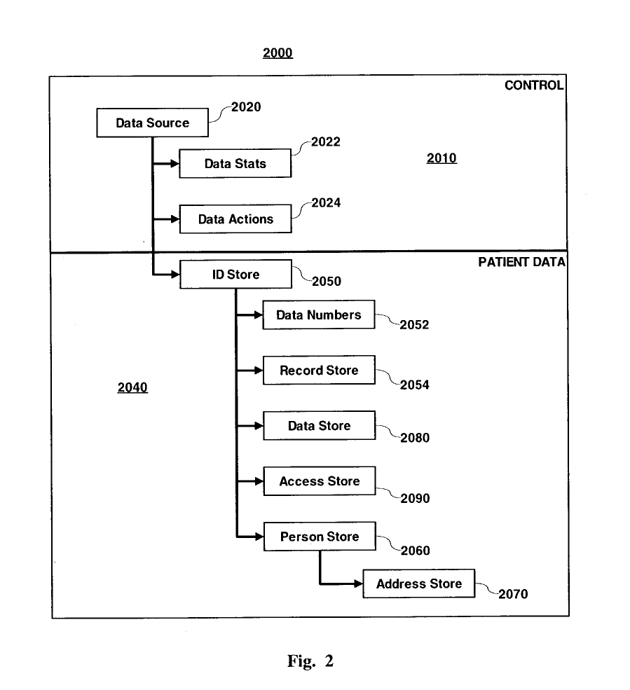

FIG. 2 is a block diagram of an exemplary embodiment of a table structure 2000 of the present invention. Control Tables 2010 are illustrated in the upper portion of FIG. 2 and may reside in a single database for maintenance purposes, but their contents may be replicated into other database locations or environments for local use, as described above. Within Control Tables 2010, Data Source table 2020 is the root table for any data access.

An external data source identifier (ID), which may be an assigned customer key, is the entry point into the Data Source table 2020. Other attributes in the root records identify what database contains the patient data, what system/machine the database is on, what the major entry key to the desired record in that database is, and if the data must be read as a current view or a combination of current and historical data. As new (empty) databases are added, rows in this table may be pre-populated based on an algorithm that will allow physical partitioning based on the determined size of the database records for a new customer. The algorithm partitions the database according to predetermined data occupancy thresholds, expected data record sizes, and physical memory storage capacity of memory devices.

Data Statistics (Stats) table 2022 records the expected monthly growth rate for a given data source as well as actual data updated periodically. Data Actions table 2024 contains some processing control information to help parse the transactions (e.g., whether they are in the HL7 or XML protocol and what version thereof, whether embedded medical record numbers are unique, and/or whether a source system sends complete or partial transactions for corrections, etc.)

Patient Data Tables 2040 are illustrated in the lower portion of FIG. 2, and may reside in multiple physical databases, and potentially in multiple machines or subsystems. Each of the tables containing patient data may have an ‘active’ and an ‘historical’ physical data store (and most likely will have, after collecting data over a period of time).

Each transaction entering the system and each resulting segment of data created via the Data Update Services 1040 (of FIG. 1) is tagged with an appended identifier that is unique for the source of that data. The ID Store table 2050 is a root table containing or pointing to data that records the relationships between identifiers. Each time a new unique identifier, such as a medical record number, enters the system, it is assigned a unique sequence number, and subsequent identifiers (e.g. of different types) that enter the system on a transaction paired with, or as the only, known identifier receive the same sequence number. ID Store table 2050 need not employ start/stop dates for the time period when a data source uses any particular identifier for a patient, because each transaction is required to have an identifier that can be used to uniquely identify that patient.

Some examples may help explain how the appended identifier is used in assigning transaction messages to a correct patient. Different systems send different patient associated identifiers on different transactions. For example, patient associated identifiers may include a patient medical record identifier, an account identifier, a customer identifer, a patient visit identifier, a transaction message source identifier and/or a patient identifier. In order to get all of the different identifiers for a single patient grouped together to refer to that patient, associations are created based on a hierarchy of identifier matching. For example, in the illustrated embodiment an ADT transaction (admit/discharge transaction, i.e. visit registration) enters the system with 3 identifiers, MedRecNo, AccountNo and VisitNo. MedRecNo is defined by the institution as a unique key to patients (i.e. each patient has only one MedRecNo and each MedRecNo refers to only one patient). The same patient may, however, have many VisitNo's and AccountNo's. On the other hand, when a LAB transaction comes in for the same hospital, it might only have an AccountNo, and a RADIOLOGY transaction might only have a VisitNo. When the system first receives the ADT message with the new MedRecNo (e.g., MR#999), it assigns an identification or sequence number as an internal key (e.g. #123) as the appended identifier. ADT transactions, over time, may designate multiple account numbers (e.g., AC#111, AC#222), and multiple visit numbers (e.g., VS#111-1, VS#111-2, VS#222-1) for the same patient. All of the account and visit numbers for that patient are associated to the assigned single internal key (e.g. #123). This association further supports receiving transactions from a LAB and RADIOLOGY, for example, and assigning them to the proper patient (MR#999=internal key #123) as well.

Data Numbers table 2052 contains the next available number for sequence number assignment to patients. Record Store table 2054 holds the transaction image of the data as it entered the system, divided into multiple rows if necessary. In the event a transaction is incorrectly associated with the wrong person ID, the transaction information in the Record Store table 2054 may be associated with the correct person, and an ID CHANGE field in the Record Store table 2054 could be set to indicate the manual move. In addition, a STATUS field could be included in the transaction record, and set to indicate the invalidity of the association of this transaction with the original patient. The presence of the status field, where the interface is known to do complete replacements, allows a user to filter the records on this field, thereby extracting the rows in the Record Store table 2054 that have been manually corrected in the normal displays of that table. A TYPE field identifies processing logic to apply to the data. For example, the TYPE field may contain a value indicating the transaction protocol, e.g. HL7, according to which the transaction data must be processed. A MATCH KEY field, which points to the location within the Record Store table 2054 containing the transaction data, is provided to aid this replacement process by obviating the need to parse the stored data to find the matching transaction.

Person Store 2060 and Address Store 2070 contains normal demographic data (e.g., name, address, phone number, birth date, gender, and/or race, etc.). Data Store 2080 contains additional auxiliary data. Access Store 2090 may provide an audit of who has accessed a specific patient's data.

In storing a transaction message data image, the core data from the message, i.e. that portion of the message not including ID information, is extracted from the transaction message and stored substantially unchanged, in field delimited form in the same format it was received. The system need not extensively process the transaction message core data to extract meaning or structure from the data other than to identify the location of the patient identifier within the data. If the transaction message is compatible with an industry-standard like HL7, the structure of the data is known and may be processed and translated. However, this is largely unnecessary since the repository itself need not process the data.

The message type, customer identifier, and patient identifier information in the message is used in processing the transaction message data and in storing the data in a particular repository location. Specifically, the message type indicates where to find a Patient Identifier within the message. A Customer Identifier may also be used to specify where to store the data. Also, the Patient Identifier (associated with customer identifier) may indicate the “root key”, in this case, which patient to associate this message with.

Certain embodiments of the present invention may serve as a generic extension to a single HIS data repository system, as a generic extension of a data repository for multiple HIS's, and/or as a general health industry data repository, for purposes such as regional health surveillance.

In any event, the embodiments of the techniques of the invention are not limited to health care and HIS's. That is, any long term data store could be created from transaction data streams, providing there is some standard within the data streams around which to build the necessary parsing and identification capabilities.

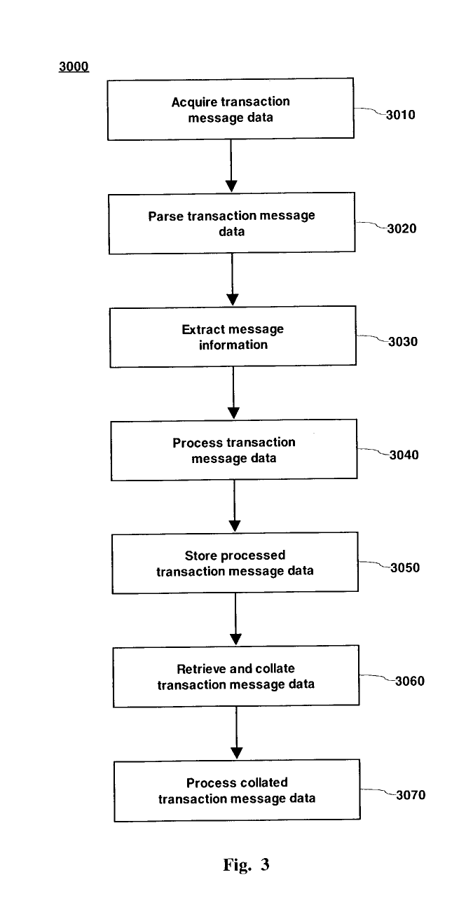

FIG. 3 is a flow diagram of an exemplary embodiment of a method 3000 according to principles of the present invention. At activity 3010, transaction message data, such as healthcare transaction message data, is acquired in any of a plurality of data formats. At activity 3020, the transaction message data is parsed. At activity 3030, message information is extracted based on the parsing of the transaction message data. For example, in blocks 3020 and 3030 a message content type is extracted. As a further example, using the message content type, patient-associated identifier information is also extracted from the transaction message data.

At activity 3040, the transaction message data is processed for storage in a structured repository at a location specified using the extracted patient-associated identifier information. The location may further be associated with a source of the transaction message data, with a customer, and/or with a patient. At activity 3050, the transaction message data is stored in the structured repository at the specified location. The above activities deal with storing transaction data, those which follow deal with retrieving previously stored data. At activity 3060, transaction message data associated with a particular source, customer, and/or patient is retrieved and sorted, in some cases in response to a user command, as described in more detail below. At activity 3070, the sorted transaction message data is processed for access by a user. Sorted transaction message date may be supplied to an HIS 1010 (of FIG. 1) which requested the data via the Data Access Services 1090.

For this particular example, the following query depicts exemplary pseudo-code for accessing Data Repository 1050 (of FIG. 1):

SELECT field list

FROM Record_Store, Id_Store

WHERE ID_PERS_ID = :WS-ID

AND ID_PERS_IDT = :WS-IDT
AND ID_SOURCE = :WS-SOURCE
AND RS_SOURCE = :WS-SOURCE
AND RS_INT_ID = ID_IN_ID
AND RS_STATUS = ''

ORDER BY RS_SYSTEM

,RS_TS
,RS_SEQ

In this query, ID_PERS_ID, ID_PERS_IDT, and ID_SOURCE refer to fields in the ID store table 2050; RS_SOURCE, RS_INT_ID and RS_STATUS refer to fields in the Record Store table 2054; and WS-ID, WS-IDT, WS-SOURCE and ID_INT_ID refer to desired values for the corresponding fields. Those records in the Record Store table 2054 and ID Store table 2050 having the desired values in the appropriate fields are then found, and listed in the order specified by the RS_SYSTEM, RS_TS and RS_SEQ fields from the Record Store table 2054, all in a known manner. The Record_Store table 2054 and Id_Store table 2050 (FIG. 2) in this query may reference views that join the active and historical databases. The record_store query above may be used to retrieve data for a given patient (ID) from a particular source. One skilled in the art will understand that the above query is merely one of a wide variety of queries which may be generated for the data in the Data Repository 1050.

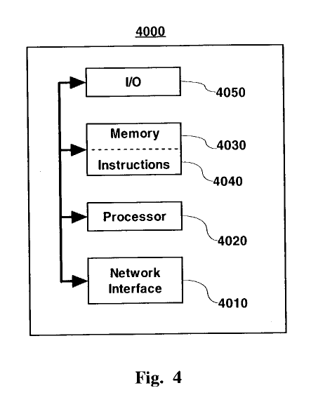

FIG. 4 is a block diagram of an exemplary embodiment of a typical information device 4000, which may architecturally support any of the functions of any component of system 1000 (of FIG. 1). Information device 4000 may include well-known components such as one or more network interfaces 4010, one or more processors 4020, one or more memories 4030 containing instructions 4040, and/or one or more input/output (“I/O”) devices 4050, all interconnected in a known manner. For example, the network interface 4010 may be a telephone with a traditional data modem, a fax modem, a cable modem, a digital subscriber line interface, a bridge, a hub, a router, and/or other similar devices. The processor 4020 may be a general-purpose microprocessor, such a Pentium series microprocessor manufactured by the Intel Corporation of Santa Clara, Calif. or an Application Specific Integrated Circuit (ASIC), which has been designed to implement in its hardware and/or firmware at least a part of a method in accordance with an embodiment of the present invention. The memory 4030 is coupled to a processor 4020 and includes a section to store instructions 4040 adapted to be executed by processor 4020 according to one or more activities of method 3000 (of FIG. 3). The instructions 4040 embody software, which may take any of numerous forms that are well known in the art. Memory 4030 may be any device capable of storing analog or digital information, such as a hard disk, Random Access Memory (RAM), Read Only Memory (ROM), flash memory, a compact disk, a magnetic tape, a floppy disk, etc., and any combination thereof. The I/O device 4050 may be an audio and/or visual device, including, for example, a monitor, display, keyboard, keypad, touch-pad, pointing device, microphone, speaker, video camera, camera, scanner, and/or printer, etc., and may include a port to which an I/O device may be attached, connected, and/or coupled.

What is claimed is:

1. A system for providing a generic data repository, comprising:
an input processor for acquiring transaction message data in at least one of a plurality of different data formats;
a data processor for:
parsing said transaction message data and extracting message content type and associated identifier information from said transaction message data, using said extracted message content type in extracting said associated identifier information from said transaction message data, and
processing said transaction message data for storage in a structured repository in a location specified using said associated identifier information; and
a storage processor for storing said processed transaction message data in said structured repository.

2. A system according to claim 1, wherein said data processor parses transaction message data of a plurality of different types and processes said transaction message data of different types for storage in data fields of said structured repository irrespective of transaction message content.

3. A system according to claim 1, wherein said extracted message content type identifies a location of said associated identifier information in said transaction message data.

4. The system of claim 1 wherein the transaction message data is healthcare transaction message data which includes patient identifier information as the associated identifier information.

5. A system according to claim 4, wherein said patient associated identifier information comprises at least one of, (a) a patient medical record identifier, (b) an account identifier, (c) a customer identifier, (d) a patient visit identifier, (e) a transaction message source identifier and (f) a patient identifier.

6. A system according to claim 4, further comprising:
a database associating said patient associated identifier information with at least one of, (a) a patient medical record identifier, (b) an account identifier, (c) a customer identifier, (d) a patient visit identifier, (e) a transaction message source identifier and (f) a patient identifier; and wherein,
said data processor uses said database in specifying the structured repository storage location associated with a specific patient for storing said transaction message data.

7. A system according to claim 1, wherein said transaction message data is processed for storage by placing data items of said transaction message in data fields of said structured repository substantially unchanged.

8. A system according to claim 1, wherein said data processor further extracts at least one of, (a) transaction message source identification information and (b) customer identification information associated with said transaction message, from said transaction message data.

9. The system of claim 8, further comprising:
a database associating said transaction message source identification information and said customer identification information; and wherein,
said data processor uses said database in specifying the structured repository storage location for storing said transaction message data.

10. A system according to claim 1, wherein said transaction message data comprises at least one of, (a) a communication to a healthcare enterprise laboratory, (b) a communication to a healthcare enterprise pharmacy, (c) a communication to a healthcare enterprise radiology department, (d) a communication to a healthcare enterprise modality department, (e) a communication to a healthcare enterprise administration operation and (f) a communication to a healthcare enterprise orders or results management operation.

11. A system according to claim 1, wherein said data processor processes said transaction message data based on said extracted content type identification information by converting said transaction message data to a data format compatible with storage of said content type in said structured repository.

12. A system for providing a healthcare data repository, comprising:
an input processor for acquiring healthcare transaction message data in at least one of a plurality of different data formats;
a data processor for,
parsing said transaction message data and extracting message content type, patient associated identifier information, and customer associated identifier information from said transaction message data, using said extracted message content type in extracting said patient associated identifier information and customer associated identifier information from said transaction message data, and
processing said transaction message data for storage in a structured repository in a location associated with the associated customer and the associated patient, said customer and patient associated location being specified using said patient associated identifier information and said customer associated identifier information; and
a storage processor for storing said processed transaction message data in said structured repository.

13. A system according to claim 12, wherein said patient associated identifier information comprises at least one of, (a) a patient medical record identifier, (b) an account identifier, (c) a customer identifier, (d) a patient visit identifier, (e) a transaction message source identifier and (f) a patient identifier.

14. A system according to claim 12, wherein said customer is at least one of, (a) a party to said transaction involving said transaction message data and (b) a source of said transaction message data.

15. A system according to claim 12, wherein said data processor specifies said storage location using a database associating a plurality of patient associated identifiers comprising at least two of, (a) a patient medical record identifier, (b) an account identifier, (c) a customer identifier, (d) a patient visit identifier, (e) a transaction message source identifier and (f) a patient identifier.

16. A system according to claim 15, wherein said data processor generates and associates a patient specific identifier to said transaction message data and said patient specific identifier is associated with individual identifiers of said plurality of patient associated identifiers.

17. A system according to claim 12, further comprising:
a database associating said patient specific identifier to at least one of, (a) a patient medical record identifier, (b) an account identifier, (c) a customer identifier, (d) a patient visit identifier, (e) a transaction message source identifier and (f) a patient identifier; and wherein,
said data processor uses said database in specifying said structured repository location associated with said customer and said patient, for storing said transaction message data.

18. A system according to claim 12, wherein
said extracted message content type identifies a location of said patient associated identifier information in said transaction message data.

19. A system for providing a healthcare data repository, comprising:
an input processor for acquiring healthcare transaction message data in at least one of a plurality of different data formats; and
a data processor for,
parsing said transaction message data and extracting message content type and patient associated identifier information from said transaction message data, using said extracted message content type in extracting said patient associated identifier information from said transaction message data,
processing said transaction message data for storage in a structured repository location associated with a source of said transaction message data and a patient, said source and patient associated location being specified using said patient associated identifier information,
retrieving and collating transaction message data associated with a particular source in response to user command; and
processing said collated transaction message data for access by a user.

20. A system according to claim 19, wherein
said data processor retrieves and collates transaction message data according to at least one of, (a) a patient identifier, (b) a customer identifier, and (c) a message source identifier; and
said processing step comprises processing said collated transaction message data for access by a user.

21. A system according to claim 20 wherein the data processor further retrieves and collates transaction message data according to at least one of, (a) an account identifier, (b) a patient visit identifier.

22. A system according to claim 20 wherein the patient identifier is a patient medical record identifier number.

23. A system for providing a healthcare data repository, comprising:
an input processor for acquiring healthcare transaction message data in at least one of a plurality of different data formats;
a data processor for,
extracting message content type and patient associated identifier information from said transaction message data,
processing said transaction message data for storage in a structured repository in a location specified using said patient associated identifier information; and
a storage processor for storing said processed transaction message data in said structured repository.

24. A system for providing a healthcare data repository, comprising:
means for acquiring healthcare transaction message data in at least one of a plurality of different data formats;
means for parsing said transaction message data and extracting message content type and patient associated identifier information from said transaction message data;
means for using said extracted message content type in extracting said patient associated identifier information from said transaction message data;
means for processing said transaction message data for storage in a structured repository in a location specified using said patient associated identifier information; and
means for storing said processed transaction message data in said structured repository.

25. A method for providing a healthcare data repository, comprising the steps of:
acquiring healthcare transaction message data in at least one of a plurality of different data formats;
parsing said transaction message data and extracting message content type and patient associated identifier information from said transaction message data;
using said extracted message content type in extracting said patient associated identifier information from said transaction message data;
processing said transaction message data for storage in a structured repository in a location specified using said patient associated identifier information; and
storing said processed transaction message data in said structured repository.

26. A method for providing a healthcare data repository, comprising the steps of:
acquiring healthcare transaction message data in at least one of a plurality of different data formats;
parsing said transaction message data and extracting message content type and patient associated identifier information from said transaction message data,
using said extracted message content type in extracting said patient associated identifier information from said transaction message data;
processing said transaction message data for storage in a structured repository location associated with a customer and a patient, said customer and patient associated location being specified using said patient associated identifier information; and
storing said processed transaction message data in said structured repository.

27. A method for providing a healthcare data repository, comprising the steps of:
acquiring healthcare transaction message data in at least one of a plurality of different data formats;
parsing said transaction message data and extracting message content type and patient associated identifier information from said transaction message data, using said extracted message content type in extracting said patient associated identifier information from said transaction message data,
processing said transaction message data for storage in a structured repository location associated with a source of said transaction message data and a patient, said source and patient associated location being specified using said patient associated identifier information;
retrieving and collating transaction message data associated with a particular source in response to user command; and
processing said collated transaction message data for access by a user.

28. A computer-readable medium containing instructions for activities comprising:
acquiring healthcare transaction message data in at least one of a plurality of different data formats;
parsing said transaction message data and extracting message content type and patient associated identifier information from said transaction message data, using said extracted message content type in extracting said patient associated identifier information from said transaction message data;
processing said transaction message data for storage in a structured repository in a location specified using said patient associated identifier information; and
storing said processed transaction message data in said structured repository.
